(19) United States
(12) Patent Application Publication
(10) Pub. No.: US 2010/0156936 A1
(43) Pub. Date: Jun. 24, 2010

(54) DEFORMATION METHOD OF ANALYSIS MODEL AND COMPUTER

(75) Inventors: Kazunari MAEDA, Tokyo (JP); Makoto ONODERA, Mito (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi, Ltd.

(21) Appl. No.: 12/554,359

(22) Filed: Sep. 4, 2009

(30) Foreign Application Priority Data
Dec. 18, 2008 (JP) 2008-321730

(51) Int. Cl. G09G 5/00; G06F 17/30

(52) U.S. Cl. 345/647; 382/218; 707/772; 707/723; 707/E17.03

(57) ABSTRACT

In a computer including a controller, a storage unit, an input unit, and a display unit, the controller displays, on the display unit, a similar shape search screen for searching a partial shape (second shape) similar to a partial shape (first shape) which composes an analysis model. When the first shape is specified using the input unit, the controller searches a feature shape database of the storage unit for the second shape similar to the first shape, and displays the search result on the display unit. The controller specifies geometric information of the first shape corresponding to geometric information of the searched second shape, deforms the analysis model based on the specified geometric information and the deformation pattern information of the second shape stored in the feature shape deformation database of the storage unit, and displays the analysis model after the deformation on the display unit.

### BACKGROUND OF THE INVENTION

The present invention relates to CAE (Computer Aided Engineering) which simulates numerically a physical phenomenon of an object by numerical analysis with a computer, especially relates to technology of creating an analysis model in CAE.

By utilizing CAE in a product development process, reduction of development cost and shortening of a cycle for design and development have been achieved. In CAE, an analysis model is created from shape data etc. created by a CAD (Computer Aided Design) system, and using the analysis model, strength analysis, fluid analysis, vibration analysis, etc. are conducted with analytic methods, such as a finite element method and a boundary element method. In creating an analysis model in CAE, it is necessary to perform operation of making a mesh data from shape data first, and operation to set up a parameter, boundary condition, etc. for each mesh in the mesh data. Therefore, for an analysis model creator (hereafter called a user), creating of an analysis model has taken much time and become a workload.

As a pertinent art, U.S. No. 2003-0058259, for example, discloses an art in which corresponding plural reference points are set to an existing analysis model (mesh model), and the existing analysis model is deformed by moving the reference points, based on the correspondence relation of these reference points and the existing analysis model, thereby a target analysis model is created. U.S. No. 2006-0235653 discloses another art in which a geometric feature is recognized from an external element surface of an existing analysis model (mesh model), and the existing analysis model is deformed so as to agree with the recognized geometric feature, thereby a target analysis model is created. These arts can shorten time required for creating of an analysis model.

Japanese Patent Application Laid-open Publication No. 2008-90766, paragraph 0009 also discloses an art in which an analysis model (mesh model) is deformed, and linked to the deformation, a shape model corresponding to the analysis model before deformation is deformed.

### SUMMARY OF THE INVENTION

The art disclosed by U.S. No. 2003-0058259 which controls a deformation part by the reference points, and the art disclosed by U.S. No. 2006-0235653 which utilizes the geometric feature to perform parametric deformation of a size, have extremely high effectiveness.

However, U.S. No. 2003-0058259 failed to disclose an art in which an analysis model is deformed based on a design parameter relevant to a partial shape unit as a feature, for example, a partial shape such as a width of a rib and a diameter of a hole.

In the art disclosed by U.S. No. 2006-0235653, it is necessary to specify a geometric feature recognized from an analysis model explicitly, and in order to deform an existing analysis model to a target analysis model, it is necessary to repeatedly execute a basic deformation function, for example, a function to change distance between two planes, and a function to change a diameter of a cylinder surface. Therefore, there remains a problem from a viewpoint of reduction of a user's workload and shortening of time required for deforming an analysis model.

Japanese Patent Application Laid-open Publication No. 2008-90766 also failed to disclose an art of shortening time required for deforming an analysis model itself.

The present invention has been made in view of the above circumstances and provides an art which can ease a workload of a user in deforming an analysis model, and which can shorten time required for deforming an analysis model.

A computer to which the present invention is applied includes a controller, a storage unit, and a display unit.

The storage unit stores plural pieces of analysis model data, plural pieces of partial shape data, and deformation pattern information relevant to each partial shape.

When deformation of the partial shape, such as size change or diameter change of the partial shape, is made, each data at the time of the deformation, such as the size change or the diameter change, is stored in the storage unit by the controller as the deformation pattern information of the partial shape.

When an analysis model as a deformation target is specified, the controller displays, on the display unit, a similar shape search screen for searching a partial shape (a second shape) similar to a partial shape (a first shape) which composes the analysis model. When the first shape is specified, the controller searches the storage unit for the second shape similar to the first shape, and displays the search result on the display unit. In searching, the controller calculates the degree of similarity based on feature quantity of the first shape and feature quantity of the second shape.

The controller specifies geometric information of the first shape corresponding to geometric information of the searched second shape, deforms the analysis model based on the specified geometric information and the deformation pattern information, and displays the analysis model after the deformation on the display unit.

According to the present invention, it is possible to ease a workload of a user in deforming an analysis model, and to shorten time required for deforming the analysis model.

### BRIEF DESCRIPTION OF THE DRAWINGS

FIG. 1 is a drawing for explaining a function of a computer;

FIG. 2 is a drawing illustrating an example of a screen on which feature shape deformation data is registered;

FIG. 3A is a drawing illustrating an example of a data configuration stored in a feature shape deformation database;

FIG. 3B is a similar drawing illustrating an example of a data configuration stored in the feature shape deformation database;

FIG. 3C is a similar drawing illustrating an example of a data configuration stored in the feature shape deformation database;

FIG. 3D is a similar drawing illustrating an example of a data configuration stored in the feature shape deformation database;

FIG. 4 is a drawing illustrating an example of an operation screen on which analysis model data is specified;

FIG. 5 is a drawing illustrating an example of a similar shape search screen;

FIG. 6 is a drawing illustrating an image of similar shape searching;

FIG. 7 is a drawing illustrating an example of a similar shape search result screen;

FIG. 8 is a flow chart illustrating a process performed by a feature shape deformation data correcting unit;

FIG. 9 is a drawing illustrating an example of a reference line/reference point setting screen;

FIG. 10 is a drawing illustrating an example of a deformation parameter input screen;

FIG. 11A is a drawing for explaining an example of application of an analysis model creation method in which an existing analysis model is deformed to create a new analysis model;

FIG. 11B is a similar drawing for explaining an example of application of the analysis model creation method in which an existing analysis model is deformed to create a new analysis model;

FIG. 11C is a similar drawing for explaining an example of application of the analysis model creation method in which an existing analysis model is deformed to create a new analysis model; and

FIG. 12 is a block diagram illustrating a hardware configuration of the computer to which the present invention is applied.

### DESCRIPTION OF THE PREFERRED EMBODIMENTS

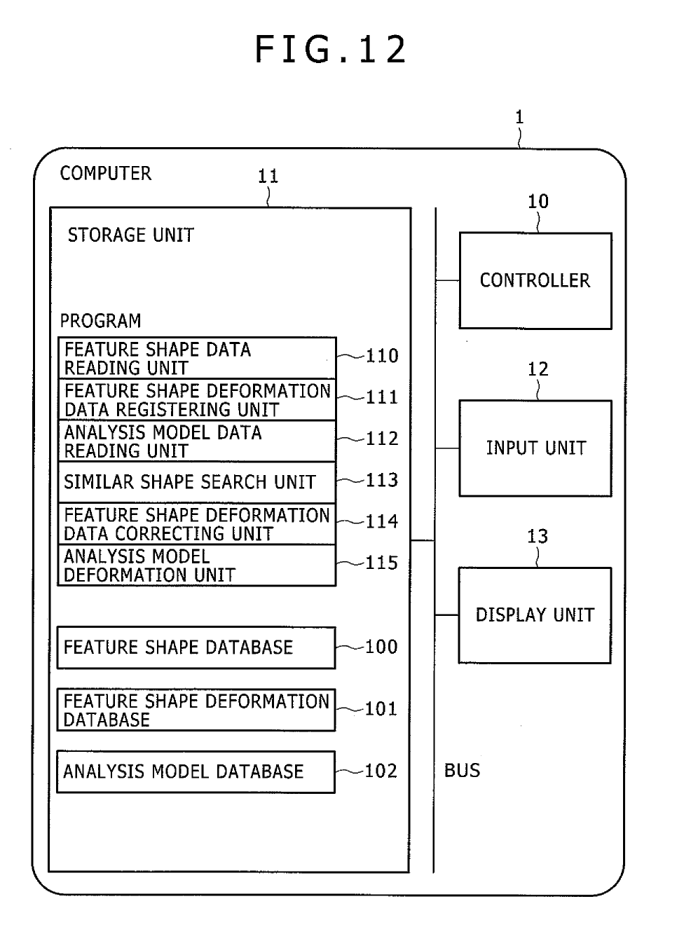

Hereafter, an embodiment of the present invention is explained in detail with reference to the accompanying drawings. First, with reference to FIG. 12, a hardware configuration is explained for a computer 1 to which the present invention is applied. The computer 1 includes a controller 10 such as a CPU (Central Processing Unit), a storage unit 11 such as an HDD (Hard Disk Drive), an input unit 12 such as a keyboard and a mouse, and a display unit 13 such as a display. Each unit is coupled to a BUS. The storage unit 11 stores a program which includes a feature shape data reading unit 110, a feature shape deformation data registering unit 111, an analysis model data reading unit 112, a similar shape search unit 113, a similar shape deformation data correcting unit 114, and an analysis model deformation unit 115. The storage unit 11 also stores a feature shape database 100, a feature shape deformation database 101, and an analysis model database 102.

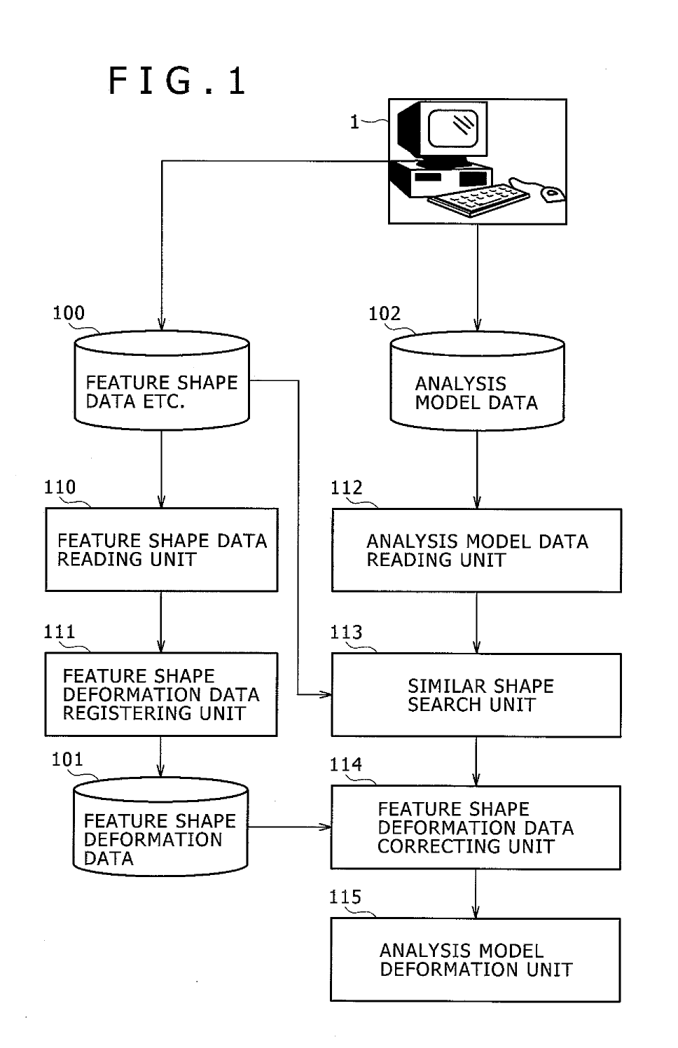

Next, with suitable reference to drawings from FIG. 1 to FIG. 11C, a function of the program, an example of a data configuration stored in each database, and an example of an input-output screen are explained. Although the program is essentially executed by the controller 10, the program is assumed in the following to be an execution subject, for the sake of convenience in explanation, and a process executed by the program is explained.

### (Registration of Feature Shape Deformation Data)

Returning to FIG. 1, the explanation is continued.

First, when a user performs operation of directing read-out of the feature (portion) shape data (mesh data) of a deformation target, using the input unit 12, the feature shape data reading unit 110 reads the directed feature shape data from the feature shape database 100, and displays a 3-dimensional CAD image of the feature shape on the display unit 13. When reading the feature shape data from the feature shape database 100, the feature shape data reading unit 110 calculates geometric feature data by performing a geometric feature recognition based on the feature shape data, and stores the calculated geometric feature data in the feature shape database 100, in an associated manner with the feature shape data.

Specifically, to an external surface of the feature shape data, the feature shape data reading unit 110 recognizes an element side (external element surface) which exhibits the geometry features, such as a plane, a cylinder surface, a conical surface, a spherical surface, a torus surface, and a free-curved surface. At the same time, the feature shape data reading unit 110 recognizes geometric kinds of a segment (a straight line, an arc, a free-form curve, etc.) which is formed by a set of element edges forming a boundary of the geometric feature in the external element surface. The shape model data reading unit 110 recognizes further a nodal point of an intersection of these segments in the geometric feature as a geometric point. The shape model data reading unit 110 imparts a uniquely-identifiable identifier (hereafter called ID) to each geometric feature of the side, the line, and the point, and stores them in the feature shape database 100 as the geometric feature data, in an associated manner with the feature shape data.

Therefore, the geometric feature data includes, with respect to a surface, ID of the surface, an external element surface recognized as the same geometry feature, a kind of geometric feature in the external element surface, and a parameter (geometric value) of the geometric feature. The geometric feature data also includes, with respect to a line, ID of the line, a kind of geometry of the recognized element edge and segment, and a parameter of the geometric feature. The geometric feature data also includes, with respect to a point, ID of the point, the recognized nodal point, and the pertaining coordinate value.

In this way, the geometric feature data which is calculated based on the feature shape data is stored in the feature shape database 100, in an associated manner, for every piece of feature shape data. The feature quantity to the feature shape which is calculated in advance by using an art described in U.S. No. 2007-0242083 is also stored in the feature shape database 100, in an associated manner with the feature shape data.

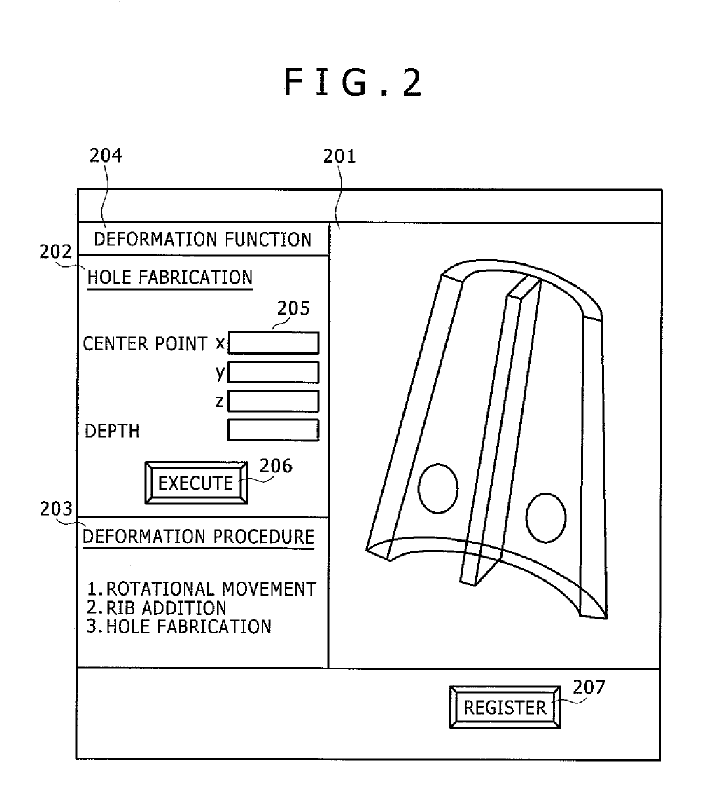

FIG. 2 illustrates an example of a display screen of a feature shape. As illustrated in FIG. 2, the present display screen includes a feature shape display area 201 which displays a 3-dimensional CAD image of a feature shape, a deformation parameter input area 202 to which a deformation parameter for performing various deformations (size deformation, rotational movement, rib addition, hole addition, etc.), and a deformation procedure display area 203 which displays a kind of deformation performed to the feature shape in order of deformation. The displayed content of the deformation parameter input area 202 changes corresponding to the content of deformation. On the display screen illustrated in FIG. 2, when a user performs operation to depress the deformation function 204 using the input unit 12, a menu for selecting deformation functions, such as a hole fabrication function, a size change function, and a rib addition function, is displayed on the display screen. Here, when the user performs operation to select a hole fabrication function using the input unit 12, for example, an input column 205 of a deformation parameter necessary to execute the hole fabrication function and an “execute” button 206 are displayed on the display screen, as illustrated in FIG. 2.

Next, on the display screen illustrated in FIG. 2, when the user inputs a deformation parameter into the deformation parameter input column 205 using the input unit 12 and performs operation to depress the “execute” button 206, the feature shape deformation data registering unit 111 performs deforming of the feature shape data based on the inputted deformation parameter, and displays the 3-dimensional CAD image on the feature shape display area 201. The deformation data including the deformation parameter (deformation geometric information) is stored in a memory by the feature shape deformation data registering unit 111 in order of the deforming temporarily, and the kind of the deformation is displayed on the deformation procedure display area 203.

In this way, the user repeats the operation described above until an intended deformation feature shape is obtained. When the user confirms that the intended deformation feature shape is obtained, the user performs operation to depress a “register” button 207 using the input unit 12. In response to the operation, the feature shape deformation data registering unit 111 registers in the feature shape deformation database 101 the deformation data which has been stored in the memory temporarily.

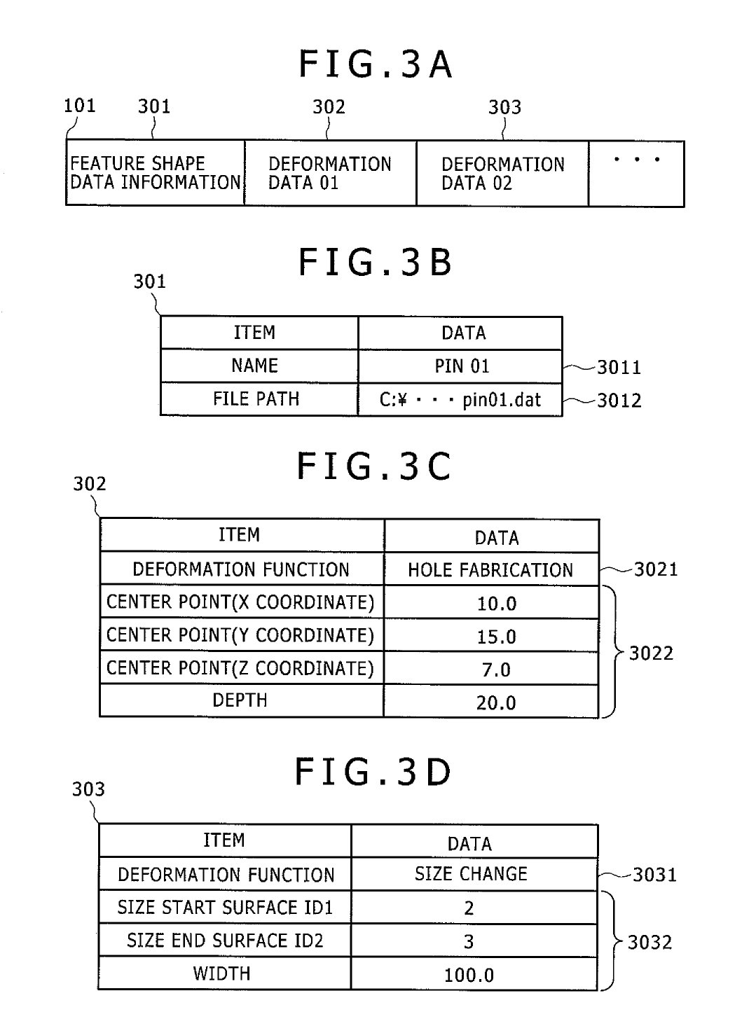

FIG. 3A illustrates an example of a data configuration registered in a feature shape deformation database 101. The feature shape data information 301 and the deformation procedure data (deformation data 302, deformation data 303, . . . ) are registered in the feature shape deformation database 101, in an associated manner with each other. As illustrated in FIG. 3B, the feature shape data information 301 is composed of a name 3011 of the feature shape data, and a file path 3012 indicating the storing position of the feature shape data. As illustrated in FIG. 3C, the deformation data 302 is composed of a name 3021 of the deformation function, and the deformation parameter 3022. As illustrated in FIG. 3D, the deformation data 303 possesses similar data configuration as the deformation data 302 and is composed of a name 3031 of the deformation function, and a deformation parameter 3032. Although not shown, plural pieces of deformation procedure data are registered in the feature shape deformation database 101 as a deformation pattern, respectively corresponding to the feature shape data information 301.

### (Deformation of Analysis Model)

Returning to FIG. 1, the explanation is continued.

Plural pieces of shape data (mesh data) serving as an analysis model are stored in the analysis model database 102.

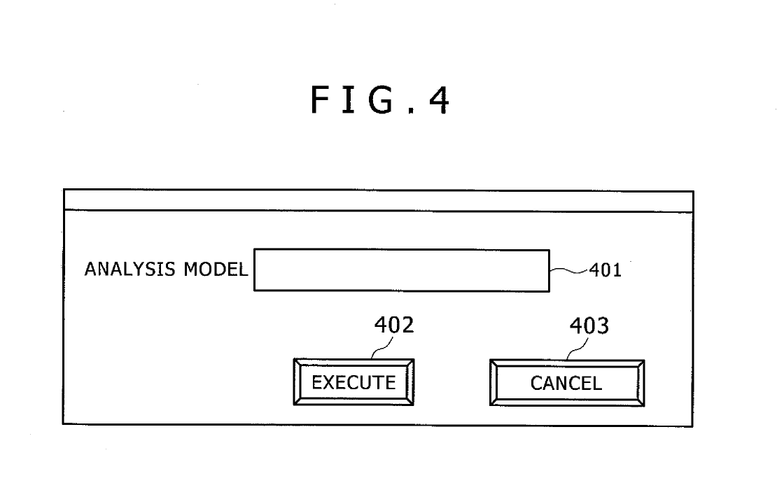

FIG. 4 illustrates an example of an operation screen on which analysis model data is specified. First, a user inputs a file name of the analysis model data into an analysis model data input field 401 using the input unit 12, and performs operation to depress an “execute” button 402. In response to the operation, the analysis model data reading unit 112 reads the specified analysis model data from the analysis model database 102, and displays the 3-dimensional CAD image on the display unit 13. When a “cancel” button 403 is depressed, the specification of the analysis model data is cancelled.

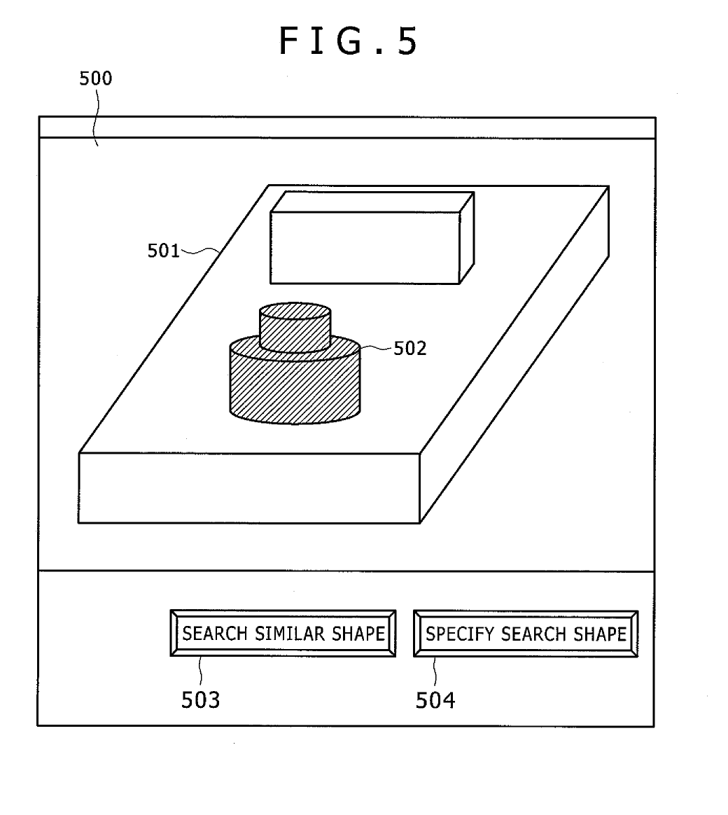

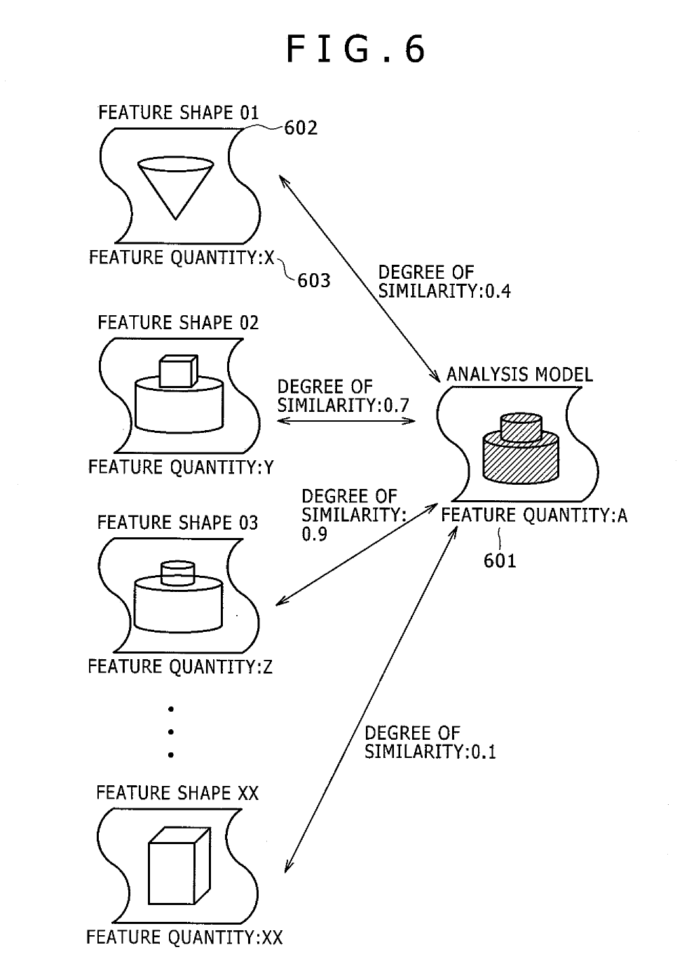

FIG. 5 illustrates an example of a display screen of the analysis model data. The present display screen is a similar shape search screen, and includes a 3-dimensional CAD image display area 500 of the analysis model, a “search similar shape” button 503, and a “specify searched shape” button 504, as illustrated in FIG. 5. When a user selects a partial shape (feature shape) 502 in the analysis model 501 currently displayed on the 3-dimensional CAD image display area 500 and performs operation to depress the “search similar shape” button 503 using the input unit 12, for example, the similar shape search unit 113 calculates feature quantity (A) 601 of the partial shape 502, as illustrated in FIG. 6, using the art described in U.S. No. 2007-0242083, and calculates sequentially the degree of similarity based on the feature quantity 601 and feature quantity (X, Y, . . . ) 603 of plural feature shapes (01, 02, . . . ) 602 stored in the feature shape database 100. The similar shape search unit 113 displays on the display unit 13 a similar-shaped candidate and the degree of similarity as the similar shape search result. On the display screen illustrated in FIG. 5, it is also possible for the user to perform operation to depress a “specify searched shape” button 504 using the input unit 12, and to display a list of feature shapes registered in the feature shape database 100 on the display unit 13, and to select a feature shape from the list.

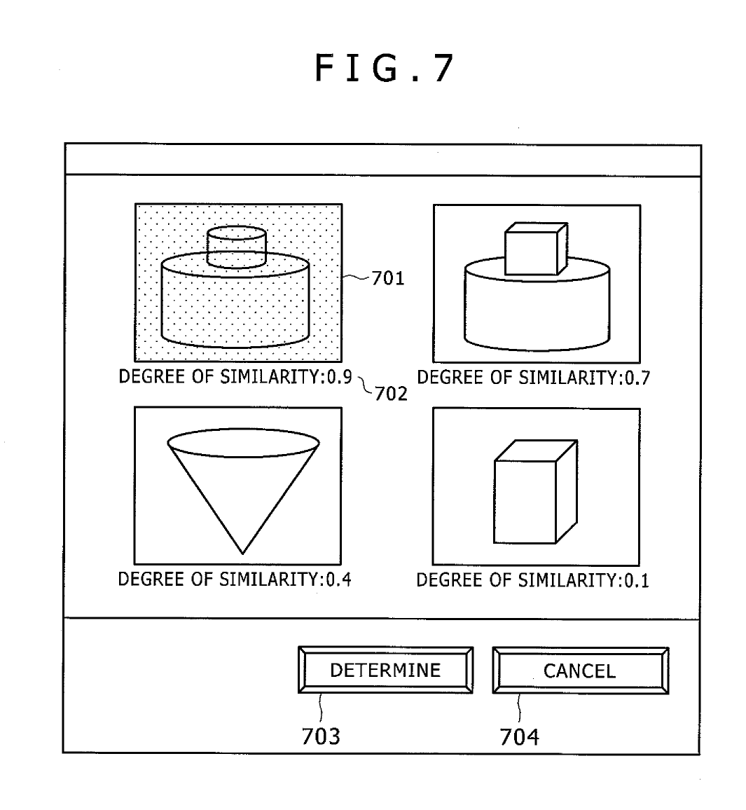

FIG. 7 illustrates an example of a similar shape search result screen. The result of the similar shape search is displayed by a list on the similar shape search result screen. In the example illustrated in FIG. 7, a searched similar-shaped candidate 701 is displayed on the similar shape search result screen with the degree of similarity 702. When the user selects one similar shape from the similar-shaped candidates and performs operation to depress a “determine” button 703 using the input unit 12, the control shifts to a process of the feature shape deformation data correcting unit 114 described later. When the user selects the similar shape 701 using the input unit 12 from the displayed similar-shaped candidates, the similar shape 701 is highlighted. The method of display of the selected similar shape 701 may not be restricted to the highlight display, but other methods may be employed, such as changing the brightness, changing the display color, reversing the display, blinking the display, displaying with a thick line, or displaying an enclosure. When the user performs operation to depress a “cancel” button 704 using the input unit 12, the control returns to the similar shape search screen.

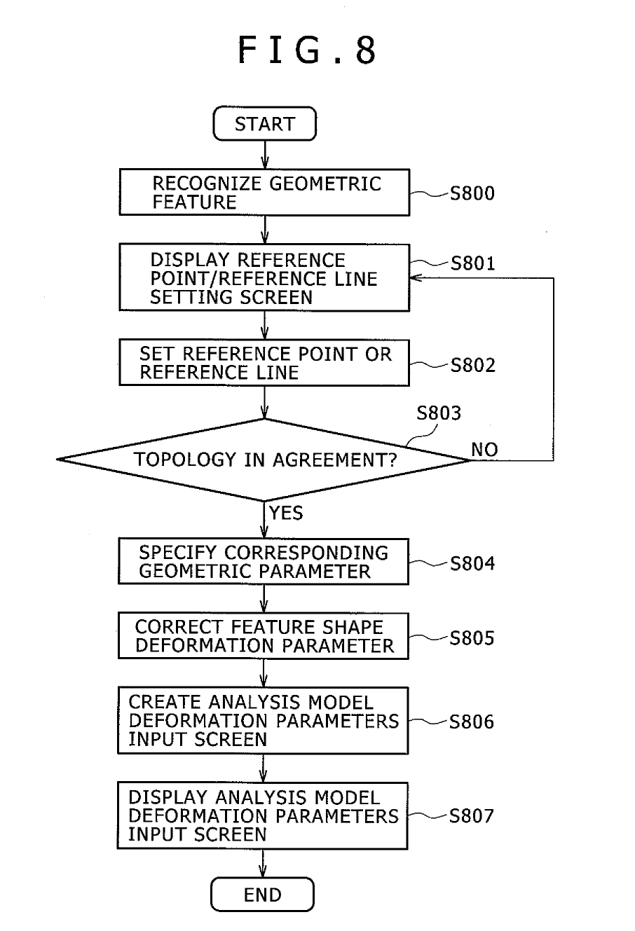

FIG. 8 is a flow chart illustrating a process performed by the feature shape deformation data correcting unit 114. First, the feature shape deformation data correcting unit 114 calculates geometric feature data by performing a geometric feature recognition processing of a partial shape which composes an analysis model, and stores the calculated geometric feature data in a memory temporarily (Step S800). The geometric feature recognition processing in the present case is the same as the geometric feature recognition processing performed by the feature shape data reading unit 110 as described above. Each geometric feature of the recognized surface, line, and point is imparted with ID, and stored in the storage unit 11 as the geometric feature data.

Next, the feature shape deformation data correcting unit 114 displays a reference point (geometric point)/reference line (segment) setting screen on the display unit 13 (Step S801).

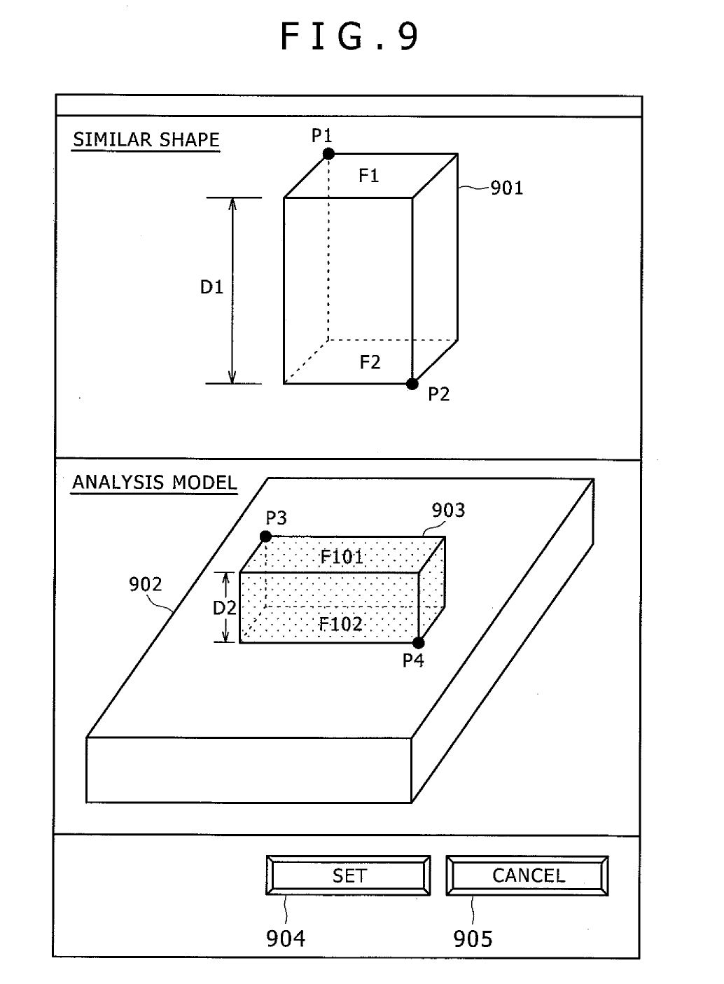

FIG. 9 illustrates an example of a reference point/reference line setting screen. As illustrated in FIG. 9, a similar shape 901 and an analysis model 902 as the deformation target are displayed on the reference line/reference point setting screen.

When a user selects a reference point (or reference line) of the similar shape (feature shape) 901 and a reference point (or reference line) of a partial shape 903 in the analysis model 902 using the input unit 12, and performs operation to depress a “set” button 904, the feature shape deformation data correcting unit 114 associates the selected reference point (or reference line) of the similar shape with the reference point (or reference line) of the partial shape 903, and stores them in the memory temporarily (Step S802).

Next, the feature shape deformation data correcting unit 114 determines whether topology is in agreement based on the reference point (or reference line) of the similar shape 901 and the reference point (or reference line) of the partial shape 903 which are stored in the memory temporarily (Step S803). To be specific, the feature shape deformation data correcting unit 114 practices the following two processes.

(1) The feature shape deformation data correcting unit 114 compares the direction of vectors one by one for adjoining segments, on the basis of the reference point (or reference line) of the similar shape 901 and the reference point (or reference line) of the partial shape 903 which are stored in the memory temporarily

(2) The feature shape deformation data correcting unit 114 compares in order the number of segments which compose a surface of which the geometric feature recognition at Step S800 and the geometric feature recognition to the similar shape 901 by the feature shape deformation data registering unit 111 have been performed. When both processes in (1) and (2) are in agreement, the feature shape deformation data correcting unit 114 determines that the topology is in agreement.

In the example illustrated in FIG. 9, for example, it is assumed that the agreement of topology is confirmed for the similar shape 901 and the partial shape 903, with combination of the following two reference points:

a reference point P1 of the similar shape 901 and a reference point P3 of the partial shape 903, and

a reference point P2 of the similar shape 901 and a reference point P4 of the partial shape 903.

It is further assumed that the followings are registered in advance, in the feature shape deformation database 101 as the deformation data of the similar shape 901:

(Deformation data 01) size change, size start surface ID: F1, size end surface ID: F2, and width: D1.

Next, the feature shape deformation data correcting unit 114 specifies the geometric parameter (size start surface, size end surface, width) of the partial shape 903 corresponding to the deformation parameter (size start surface F1, size end surface F1, width D1) of the similar shape 901, based on the agreement determination result of the topology (Step S804). In the example illustrated in FIG. 9, it can be seen that the size start surface F1 of the similar shape 901 corresponds to the size start surface F101 of the partial shape 903, and the size end surface F2 of the similar shape corresponds to the size end surface F102 of the partial shape 903, respectively.

Next, the feature shape deformation data correcting unit 114 corrects the deformation parameter (size start surface F1, size end surface F2) included in the deformation data 01 of the similar shape 901 to the geometric parameter (size start surface F101, size end surface F102) of the specified partial shape 903 (Step S805). The deformation data 01 after correction becomes as follows.

(Deformation data 01) size change, size start surface ID: F101, size end surface ID: F102, width: D1.

The feature shape deformation data correcting unit 114 calculates a distance (width) between the size start surface F101 and the size end surface F102 of the partial shape 903 (referred to as D2), and corrects the width D1 in the deformation data 01 to D2.

As a result of the process, the deformation data 01 becomes as follows.

(Deformation data 01) size change, size start surface ID: F101, size end surface ID: F102, width: D2.

Next, based on the deformation data 01, the feature shape deformation data correcting unit 114 creates an analysis model deformation parameters input screen (Step S806), and displays the screen on the display unit 13 (Step S807).

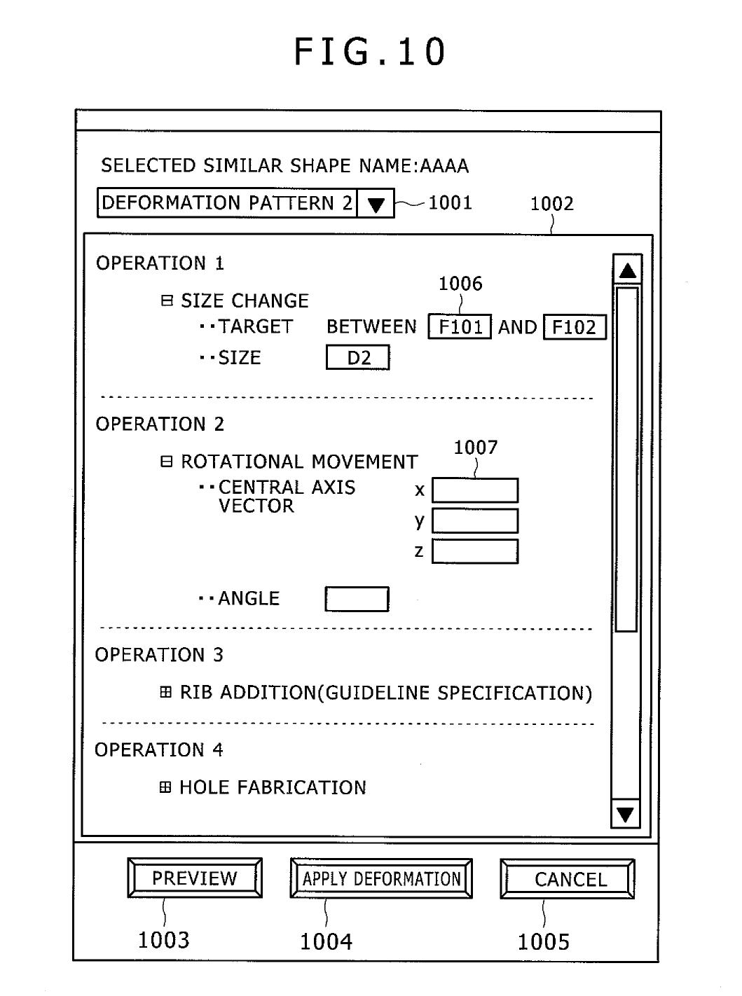

FIG. 10 illustrates an example of an analysis model deformation parameters input screen. The analysis model deformation parameters input screen is composed of a deformation pattern selection tab 1001, deformation parameter information 1002, a “preview” button 1003, an “apply deformation” button 1004, and a “cancel” button 1005. The deformation pattern selection tab 1001 can select one from plural pieces of deformation procedure data (deformation pattern data) corresponding to the similar shape 901 registered in the feature shape deformation database 101. The deformation parameter information 1002 displays the selected deformation procedure data. The “preview” button 1003 is for confirming the result of deforming of the analysis model performed based on the present deformation parameter information 1002. The “apply deformation” button 1004 is for directing application of the deformation result. The “cancel” button 1005 is for canceling the deforming of the analysis model data 902.

In the deformation parameter information 1002, a deformation parameter corrected by the feature shape deformation data correcting unit 114 is displayed in an edit box 1006. The deformation parameter in the edit box 1006 can be changed. As for a deformation parameter which has not been specified at Step S804, a blank box 1007 is displayed, and it is possible to input the deformation parameter into the blank box 1007.

When the process by the feature shape deformation data correcting unit 114 completes, then, the analysis model deformation unit 115 deforms the analysis model 902, by moving each nodal point of the analysis model data based on the parameter inputted in the analysis model deformation parameters input screen, using the publicly known mesh deformation technique, and generates a new analysis model.

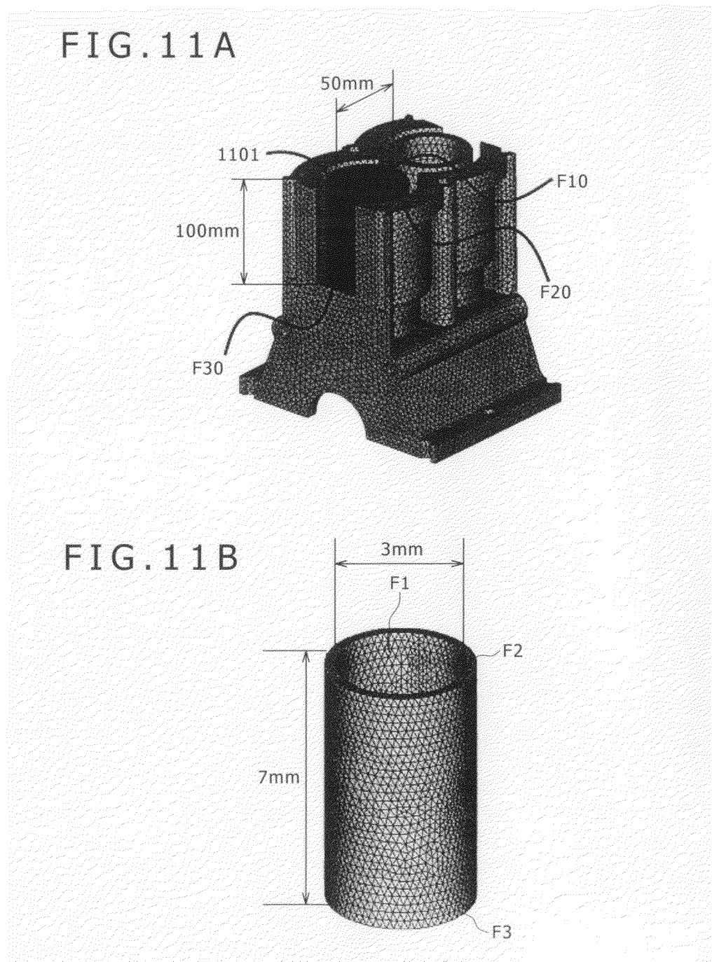

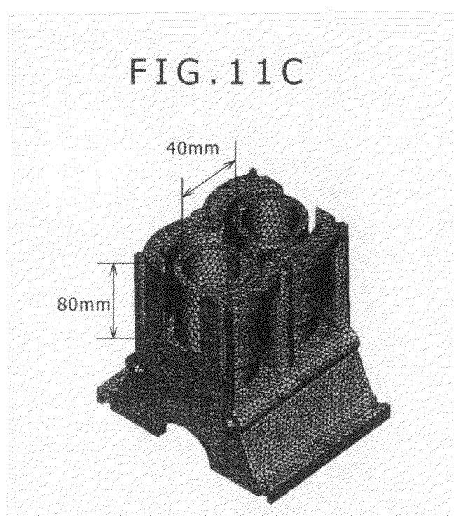

As described above, the deforming of an analysis model has been explained. In the following, an example of specific application of the analysis model deformation method in a case of deforming an existing analysis model to create a new analysis model is explained with reference to FIG. 11A-FIG. 11C.

Here, an example is explained in which a size and a diameter of a cylinder part (partial shape) 1101 of an analysis model (engine block) illustrated in FIG. 11A are changed to create a new analysis model after deformation as illustrated in FIG. 11C. In deforming the analysis model (FIG. 11A), it is assumed as a prerequisite that the deformation data of the following feature shape (FIG. 11B) is registered in the feature shape deformation database 101.

(Deformation data 01) size change, size start surface ID: F2, size end surface ID: F3, width: 7

(Deformation data 02) diameter change, cylinder surface ID: F1, diameter: 3

First, using the input unit 12, a user inputs a file name of analysis model data of a deformation target into the analysis model data input field 401 of the operation screen (FIG. 4) to specify the analysis model data, and performs operation to depress the “execute” button 402. In response to the operation, the analysis model data reading unit 112 reads the specified analysis model data (data with respect to the engine block) from the analysis model database 102, and displays a similar shape search screen (FIG. 5) on the display unit 13. An engine block (FIG. 11A) is displayed on the 3-dimensional CAD image display area 500 of the similar shape search screen. Next, when the user selects the cylinder part 1101 and performs operation to depress the “search similar shape” button 503 in the similar shape search screen, using the input unit 12, the similar shape search unit 113 calculates the degree of similarity sequentially based on the feature quantity of the selected cylinder part 1101, and the feature quantity of each of plural feature shapes registered in the feature shape database 100, and displays a similar-shaped candidate and the degree of similarity on the display unit 13, as the similar shape search result. Here, it is assumed that a 3-dimensional CAD image of the feature shape illustrated in FIG. 11B is displayed as a similar-shaped candidate on the similar shape search result screen (FIG. 7). Next, when the user select the similar shape illustrated in FIG. 11B and performs operation to depress the “determine” button 703 in the similar shape search result screen using the input unit 12, the feature shape deformation data correcting unit 114 performs a geometric feature recognition processing to the cylinder part 1101 to calculate geometric feature data (upper end surface: F20, lower end surface: F30, surface inside a cylinder: F10), and stores the data in the memory (FIG. 8, Step S800).

Next, in the reference line/reference point setting screen displayed on the display unit 13 (FIG. 8, Step S801, FIG. 9), the user selects the reference point and the reference line from each of the cylinder part 1101 illustrated in FIG. 11A, and the similar shape illustrated in FIG. 11B, using the input unit 12. Here, it is assumed that edge lines (reference lines) which compose F20 and F2 are selected to the respective shapes. The feature shape deformation data correcting unit 114 associates the respective edge lines selected, and stores them in the memory (FIG. 8, Step S802).

Next, the feature shape deformation data correcting unit 114 determines whether the topology is in agreement based on the associating information of the edge line stored in the memory (FIG. 8, Step S803).

Next, the feature shape deformation data correcting unit 114 specifies a geometric parameter of the cylinder part 1101 corresponding to the deformation parameter of the similar shape (FIG. 11B) registered in the feature shape deformation database 101 (FIG. 8, Step S804). Here, F10 corresponds to F1, F20 corresponds to F2, and F30 corresponds to F3, respectively.

Next, the feature shape deformation data correcting unit 114 corrects the deformation data 01 and 02 of the similar shape registered in the feature shape deformation database 101 to the parameter of the specified cylinder part 1101. The deformation data 01 and 02 after correction are:

(Deformation data 01) size change, size start surface ID: F20, size end surface ID: F30, width: 7

(Deformation data 02) diameter change, target cylinder surface ID: F10, diameter: 3.

The feature shape deformation data correcting unit 114 calculates distance (width) between the size start surface F10 and the size end surface F30 of the cylinder part 1101, and the diameter of the cylinder surface F10 (100 mm, 50 mm, respectively), and corrects 7 mm of the width in the deformation data 01 to 100 mm, and 3 mm of the diameter in the deformation data 02 to 50 mm (FIG. 8, Step S805). The deformation data 01 and 02 after correction are:

(Deformation data 01) size change, size start surface ID: F20, size end surface ID: F30, width: 100

(Deformation data 02) diameter change, cylinder surface ID: F10, diameter: 50.

Next, the feature shape deformation data correcting unit 114 creates an analysis model deformation parameters input screen (FIG. 10) based on the deformation data 01 and 02 after correction (FIG. 8, Step S806), and displays it on the display unit 13 (FIG. 8, Step S807).

Here, it is assumed that a user has changed the size of the cylinder part 1101 to 80 mm, and the diameter to 40 mm, using the input unit 12, for example. In this case, the contents of the deformation parameter information 1002 of the analysis model deformation parameters input screen become as follows.
(Operation 1) size change, size start surface ID: F20, size end surface ID: F30, width: 80
(Operation 2) diameter change, target cylinder surface ID: F10, diameter: 40

Next, when the user performs operation to depress the “preview” button 1003 using the input unit 12, the analysis model deformation unit 115 performs deforming of the analysis model (FIG. 11A) based on the input parameters, and displays a preview screen of the analysis model after deformation on the display unit 3. When the user confirms the analysis model after deformation and performs operation to depress the “apply deformation” button 1004 using the input unit 12, the analysis model deformation unit 115 displays the analysis model after deformation (FIG. 11C) on the display unit 13.

As explained above, according to the embodiment, it is possible to ease a workload of a user in deforming an analysis model, and to shorten time required for deforming the analysis model. Accordingly, it is possible to improve efficiency of work by a user.

According to the embodiment, deforming of an analysis model can be performed in units of a feature shape. Therefore, it is not necessary to repeatedly execute a function to change distance between two planes, or a function to change a diameter of a cylinder surface, and it is also possible to reduce a user-induced operation error.

The embodiment described above has explained for the case where the controller 10 executes the program. However, the function part of the program may be realized by hardware.

In reading the feature shape data from the feature shape database 100, when the geometric feature data of the feature shape is already stored in the feature shape database 100, the geometric feature recognition processing may not be performed.

The embodiment of the present invention has been explained in the above. The present invention is not restricted to the embodiment and can be variously changed in the range which does not deviate from the gist.

What is claimed is:

1. A deformation method of an analysis model to be executed by a computer including a control unit, a storage unit, and a display unit, the deformation method of the analysis model executed by the control unit comprising the steps of:
searching the storage unit for a second shape similar to a first shape composing the analysis model;
specifying geometric information of the first shape corresponding to geometric information of the second shape;
deforming the analysis model based on the geometric information of the first shape and deformation geometric information of the second shape stored in the storage unit; and
displaying on the display unit the analysis model after the deforming.

2. A deformation method of an analysis model to be executed by a computer including a control unit, a storage unit, and a display unit, the deformation method of the analysis model executed by the control unit comprising the steps of:
searching the storage unit for a second partial shape similar to a first partial shape composing the analysis model;
investigating correspondence relation between geometric information of the second partial shape and geometric information of the first partial shape;
correcting deformation pattern information of the second partial shape stored in the storage unit, based on the investigated result;
deforming the analysis model by use of the corrected deformation pattern information; and
displaying on the display unit the analysis model after the deforming.

3. A deformation method of an analysis model (mesh data) to be executed by a computer including a control unit, a storage unit, an input unit, and a display unit, the deformation method of the analysis model executed by the control unit comprising the steps of:
displaying on the display unit a similar shape search screen for searching a second feature shape similar to a first feature shape composing the analysis model;
calculating feature quantity of the first feature shape specified through the input unit;
searching the second feature shape similar to the first feature shape, by sequentially comparing the feature quantity concerned with feature quantity of each of a plurality of feature shapes stored in the storage unit;
displaying the searched result on the display unit;
displaying, on the display unit, the analysis model and the second feature shape, specified through the input unit;
acquiring reference geometric information of the first feature shape and reference geometric information of the second feature shape, specified through the input unit;
determining whether topology is in agreement, based on the acquired reference geometric information;
specifying geometric information of the first feature shape corresponding to the geometric information of the second feature shape, when the topology is in agreement;
correcting deformation pattern information of the second feature shape stored in the storage unit, by use of the geometric information of the first feature shape;
deforming the analysis model by use of the corrected deformation pattern information; and
displaying on the display unit the analysis model after the deforming.

4. The deformation method of the analysis model according to claim 3, further comprising the step of:
registering the deformation pattern information of the second feature shape.

5. The deformation method of the analysis model according to claim 4,
wherein the displaying on the display unit the analysis model and the second feature shape specified through the input unit is displaying on the display unit a setting screen of reference geometric information for acquiring the reference geometric information.

6. The deformation method of the analysis model according to claim 5, further comprising the steps of:
generating an input screen of a parameter relating to the first feature shape necessary for deforming the analysis model by use of the corrected deformation pattern information, after correcting the deformation pattern information of the second feature shape;
displaying the input screen on the display unit; and
deforming the analysis model by use of the input information.

7. The deformation method of the analysis model according to claim 6,
wherein the input information is changeable.

8. The deformation method of the analysis model according to claim 7,
wherein a candidate list of a plurality of similar shapes searched is displayed with the degree of similarity in the searched result.

9. A computer comprising:
a control unit;
a storage unit; and
a display unit,
wherein the control unit
searches the storage unit for a second shape similar to a first shape composing an analysis model;
specifies geometric information of the first shape corresponding to geometric information of the second shape;
deforms the analysis model based on the geometric information of the first shape and the deformation geometric information of the second shape stored in the storage unit; and
displays on the display unit the analysis model after the deforming.

10. A computer comprising:
a control unit;
a storage unit; and
a display unit,
wherein the control unit
searches the storage unit for a second partial shape similar to a first partial shape composing an analysis model;
investigates correspondence relation between geometric information of the second partial shape and geometric information of the first partial shape;
corrects the deformation pattern information of the second partial shape stored in the storage unit, based on the investigated result;
deforms the analysis model by use of the corrected deformation pattern information; and
displays on the display unit the analysis model after the deforming.

11. A computer comprising:
a control unit;
a storage unit;
an input unit; and
a display unit,
wherein the control unit
displays on the display unit a similar shape search screen for searching a second feature shape similar to a first feature shape composing an analysis model;
calculates feature quantity of the first feature shape specified through the input unit;
searches the second feature shape similar to the first feature shape, by comparing the feature quantity concerned with feature quantity of each of a plurality of feature shapes stored in the storage unit in advance;
displays the searched result on the display unit;
displays, on the display unit, the analysis model and the second feature shape, specified through the input unit;
acquires reference geometric information of the first feature shape and reference geometric information of the second feature shape, specified through the input unit;
determines whether topology is in agreement, based on the acquired reference geometric information;
specifies geometric information of the first feature shape corresponding to the geometric information of the second feature shape, when the topology is in agreement;
corrects deformation pattern information of the second feature shape stored in the storage unit, by use of the geometric information of the first feature shape;
deforms the analysis model by use of the corrected deformation pattern information; and
displaying on the display unit the analysis model after the deforming.

12. The computer according to claim 11,
wherein the control unit further registers the deformation pattern information of the second feature shape.

13. The computer according to claim 12,
wherein control performed by the control unit to display on the display unit the analysis model and the second feature shape specified through the input unit is control to display on the display unit a setting screen of reference geometric information for acquiring the reference geometric information.

14. The computer according to claim 13,
wherein the control unit further
generates an input screen of a parameter relating to the first feature shape necessary for deforming the analysis model by use of the corrected deformation pattern information, after the correction process;
displays the input screen on the display unit; and
deforms the analysis model by use of the input information.

15. The computer according to claim 14,
wherein the input information is changeable.

16. The computer according to claim 15,
wherein a candidate list of a plurality of similar shapes searched is displayed with the degree of similarity in the searched result.
